(19) United States
(12) Patent Application Publication
(10) Pub. No.: US 2013/0271323 A1
(43) Pub. Date: Oct. 17, 2013

(54) APPARATUS AND METHOD FOR FINDING THE DIRECTION OF SIGNAL SOURCE

(71) Applicant: ELECTRONICS AND TELECOMMUNICATIONS RESEARCH INSTITUTE, Daejeon (KR)

(72) Inventors: In One JOO, Daejeon (KR); Jeom Hun LEE, Daejeon (KR); Sang Uk LEE, Daejeon (KR)

(73) Assignee: Electronics and Telecommunications Research Institute, Daejeon (KR)

(21) Appl. No.: 13/863,932

(22) Filed: Apr. 16, 2013

(30) Foreign Application Priority Data
Apr. 17, 2012 (KR) 10-2012-0039637
Mar. 15, 2013 (KR) 10-2013-0027804

(51) Int. Cl. G01S 3/48

(52) U.S. Cl. CPC G01S 3/48
USPC 342/442

(57) ABSTRACT

The direction finding apparatus includes: a first and second antennas configured to receive radio signals respectively; a travel guide unit mechanically coupled with the first and second antennas and configured to provide a travel path along which the first and second antennas are linearly movable; a driver configured to provide a driving force for linearly moving at least one antenna of the first and second antennas in response to a driving control signal; a driving controller configured to provide the driving control signal, wherein the driving control signal is used to separate the first and second antennas from each other by a predetermined distance; and a direction finding unit configured to calculate an angle of arrival (AOA) of radio signals respectively received through the first and second antennas, based on the phase difference between the radio signals, and the predetermined distance.

### CLAIM FOR PRIORITY

This application claims priority to Korean Patent Application No. 10-2012-0039637 filed on Apr. 17, 2012 and No. 10-2013-0027804 Mar. 15, 2013 in the Korean Intellectual Property Office (KIPO), the entire contents of which are hereby incorporated by reference.

### BACKGROUND

1. Technical Field

Example embodiments of the present invention relate in general to a technique for finding the direction of a signal source, and more specifically, to an apparatus and method for finding the direction of a signal source, capable of accurately finding the direction of a signal source through a simple configuration.

2. Related Art

Lately, a need to actively cope with an increase in the use amount of radio waves due to the popularization of wireless communication systems, various service requirements from wireless communication users, and various deregulation requirements due to the liberalization and internationalization of a communication market is increasing. Also, needs for a fair, efficient use of limited frequency resources and for systematical establishment of the order of radio spectrum utilization are increasing.

For efficient management of radio waves, detecting regions with a low quality of radio waves, tracking the directions and locations of persons that illegally transmit radio waves, identifying persons that transmit a wider band than a licensed band, tracking causes of interference signals or noises adversely influencing the quality of radio waves due to breakdown, etc. of electrical equipments or power lines, tracking transmitters that transmit extraneous radio waves infiltrated into the country, etc. should be considered, and for this, finding the direction of a signal source that transmits a frequency band of interest must be prioritized. In order to find the direction of a signal source, generally, an array antenna configured with a plurality of antennas is used, and by comparing the magnitudes and phases of signals transmitted from a signal source and received by the plurality of antennas, the direction of the signal source is located.

According to a method of finding the direction of a signal source through comparison between phases, the direction of a signal source is located by determining an angle of arrival (AOA) using phase differences between signals received by an array antenna. The method can obtain higher resolution than a method of comparing the magnitudes of signals to each other to find the direction of a signal source.

Conventionally, a plurality of antennas and a plurality of phase detectors have been used in order to cover a wide band of frequencies and improve the accuracy of AOA detection.

FIG. 1 is a conceptual view showing a conventional method of finding the direction of a signal source.

Hereinafter, a conventional direction finding method based on multi-baseline interferometry will be schematically described with reference to FIG. 1.

Referring to FIG. 1, a conventional direction finding apparatus 100 based on multi-baseline interferometry includes a first antenna 101, a second antenna 102, a third antenna 103, a fourth antenna 104, a first phase detector 111 connected between the first antenna 101 and the second antenna 102, a second phase detector 112 connected between the first antenna 101 and the third antenna 103, a third phase detector 113 connected between the first antenna 101 and the fourth antenna 104, and an AOA calculator 121 for calculating an AOA based on phase difference values provided from the first phase detector 111 through the third phase detector 113.

In the direction finding apparatus 100 with the structure described above, the distance d12 between the first and second antennas 101 and 102 is set to a half-wavelength λ/2 so that an AOA without ambiguity can be calculated using the phase difference between signals received by the first and second antennas 101 and 102.

Meanwhile, the direction finding apparatus 100 includes the third and fourth antennas 103 and 104 for applying to a wide band of frequencies and improving the accuracy of AOA, and also includes the second and third phase detectors 112 and 113 for detecting the phase differences between signals received by the first and third antennas 101 and 103 and by the to first and fourth antennas 101 and 104.

Also, the direction finding apparatus 100 sets the distance d13 between the first antenna 101 and the third antenna 103 longer than the half-wavelength λ/2 to detect the phase difference between signals received by the first and third antennas 101 and 103, and calculates an AOA using the detected phase difference. At this time, there is an ambiguity since several AOAs are obtained; however, the ambiguity problem can be solved using the AOA calculated based on the distance d12 between the first and second antennas 101 and 102. That is, the AOA calculated based on the distance d13 has less error than the AOA calculated based on the distance d12, resulting in improvement of the accuracy of direction finding.

Meanwhile, if the distance d13 between the first antenna 101 and the third antenna 103 is set to a maximum value, this can ideally minimize the error of an AOA; however, the ambiguity problem cannot be solved since there are several AOA solutions with respect to the AOA calculated based on the distance d12.

Accordingly, the distance d13 should be restrictively increased within a range capable of solving the ambiguity problem through the AOA calculated from the distance d12.

In order to obtain an AOA with less error than the AOA calculated based on the distance d13, the first and fourth antennas 101 and 104 spaced by a distance d14 that is longer than the distance d13 are used.

Although the case of using the phase difference between signals received by the first and fourth antennas 101 and 104 produces more AOAs than the case of using the phase difference between signals received by the first and third antennas 101 and 103 so as to further increase an ambiguity, the ambiguity problem can be solved using the AOA already calculated through the distance d13 between the first and third antennas 101 and 103. Accordingly, the AOA calculated through the distance d14 has less error than the AOA calculated using the distance d13, thereby further improving the accuracy of AOA.

The conventional direction finding apparatus 100 using phase comparison, as shown in FIG. 1, can be applied to a wide band of frequencies and reduce the error of AOA, thereby improving the accuracy of AOA; however, the conventional direction finding apparatus 100 should include a plurality of antennas and a plurality of phase detectors for detecting the phase differences between signals received by the individual antennas.

Accordingly, the direction finding apparatus 100 has a complicated configuration, and the manufacturing cost of the direction finding apparatus 100 increases since a plurality of high-cost phase detectors are required.

Meanwhile, if two antennas and a single phase detector are used to solve the problem, the error of an AOA increases as the absolute value of the AOA approaches 90 degrees.

### SUMMARY

Accordingly, example embodiments of the present invention are provided to substantially obviate one or more problems due to limitations and disadvantages of the related art.

Example embodiments of the present invention provide an apparatus of finding the direction of a signal source, which has a simple configuration and which can be applied to a wide band of frequencies and improve the accuracy of direction finding.

Example embodiments of the present invention also provide a direction finding method which is performed by the direction finding apparatus.

In some example embodiments, a direction finding apparatus includes: a first and second antennas configured to receive radio signals respectively; a travel guide unit mechanically coupled with the first and second antennas and configured to provide a travel path along which the first and second antennas are linearly movable; a driver configured to provide a driving force for linearly moving at least one antenna of the first and second antennas in response to a driving control signal; a driving controller configured to provide the driving control signal, wherein the driving control signal is used to separate the first and second antennas from each other by a predetermined distance; and a direction finding unit configured to calculate an angle of arrival (AOA) of radio signals respectively received through the first and second antennas, based on the phase difference between the radio signals, and the predetermined distance.

Here, the driving controller may provide the driving control signal to linearly move the first and second antennas on the travel guide unit so that the first and second antennas are close to or away from each other.

The driving controller may also provide the driving control signal to the driver to stepwisely increase the distance between the first and second antennas.

The driving controller may further provide the driving control signal to adjust the distance between the first and second antennas to a first distance which is equal to or shorter than a half-wavelength of the radio signals, and the direction finding unit may calculate a first AOA, based on the phase difference between radio signals received through the first and second antennas spaced by the first distance, and the first distance.

After calculating the first AOA, the driving controller may provide a driving control signal for separating the first and second antennas from each other by a second distance that is longer than the first distance, and the direction finding unit may calculate a second AOA, based on the phase difference between radio signals received through the first and second antennas spaced by the second distance, and the second distance.

If a plurality of AOAs are calculated based on the phase difference between the radio signals received through the first and second antennas and the second distance, the direction finding unit may decide an AOA closest to the first AOA among the plurality of AOAs, as the second AOA.

The direction finding unit may determine whether the accuracy of AOA needs to be improved based on the calculated AOA, and if the accuracy of AOA needs to be improved, the direction finding unit may provide the driving controller with a distance control signal for setting the distance between the first and second antennas to a distance that is longer than the predetermined distance.

The direction finding unit may include: a phase detector configured to detect the phase difference between the radio signals respectively received from the first and second antennas; and an AOA calculator configured to calculate the AOA based on the detected phase difference and the predetermined distance.

In other example embodiments, a method of finding the direction of a signal source includes: moving at least one antenna of two antennas to adjust the distance between the two antennas to a first distance; calculating a first angle of arrival (AOA) of signals respectively received through the two antennas, based on the phase difference between the received signals, and the first distance; moving at least one antenna of the two antennas to adjust the distance between the two antennas to a second distance that is longer than the first distance; and calculating a second AOA of signals respectively received through the two antennas spaced by the second distance, based on the phase difference between the received signals, and the second distance.

The method may further include deciding, if a plurality of AOAs of the signals received through the two antennas spaced by the second distance are calculated based on the phase difference between the received signals and the second distance, an AOA closest to the first AOA among the plurality of AOAs, as the second AOA.

The method may further include: determining, after calculating the second AOA, whether the accuracy of AOA needs to be improved based on the calculated AOA; moving at least one antenna of the two antennas to adjust the distance between the two antennas to a third distance that is longer than the second distance, if the accuracy of AOA needs to be improved; and calculating a third AOA of signals respectively received through the two antennas spaced by the third distance, based on the phase difference between the received signals, and the third distance.

The calculating of the third AOA may include deciding, if a plurality of AOAs of the signals received through the two antennas spaced by the third distance are calculated based the phase difference between the received signals and the third distance, an AOA closest to the second AOA among the plurality of AOAs, as the third AOA.

The first distance may be set to a distance that is equal to or shorter than a half-wavelength of the received signals, and the second distance may be set to a distance that is longer than the first distance and set to a distance within a distance range in which if a plurality of AOAs of the signals received through the two antennas spaced by the second distance are calculated based on the phase difference between the received signals and the second distance, an AOA closest to the first AOA is able to be selected from among the plurality of AOAs.

According to the apparatus and method of finding the direction of the signal source, an antenna travel guide unit for changing the distance between first and second antennas, an antenna driver, and an antenna driving controller are configured to set the distance between the first and second antennas as an initial value to a distance that is equal to or shorter than a half-wavelength, and then to calculate an AOA based on the phase difference between signals received through the first and second antennas. Then, an AOA is again calculated based on the phase difference between signals received through the first and second antennas while stepwisely increasing the distance between the first and second antennas. At this time, if a plurality of AOAs are obtained in correspondence to a phase difference due to an increase in distance between the first and second antennas, an AOA closest to the previously calculated AOA among the plurality of AOAs is selected, thereby solving the ambiguity problem.

Accordingly, by configuring a direction finding apparatus with a single phase detector and a single AOA calculator, the manufacturing cost of a direction finding apparatus can be reduced.

Also, since an AOA can be calculated by freely adjusting the distance between two antennas, the direction finding apparatus can be applied to a wide band of frequencies and minimize an error of AOA calculation even in regions close to 90 degrees in which errors of AOA calculation are often generated, thereby improving the accuracy of AOA.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view showing a conventional method of finding the direction of a signal source;

FIG. 2 is a conceptual view for explaining a method of finding the direction of a signal source using phase comparison;

FIG. 3 is a graph showing the relationship between phase differences and AOAs when the distance between two antennas is a half-wavelength;

FIG. 4 is a graph showing the relationship between phase differences and AOAs when the distance between two antennas is longer than a half-wavelength;

FIG. 5 is a block diagram showing an apparatus of finding the direction of a signal source, according to an embodiment of the present invention;

FIG. 6 is a flowchart showing a method of finding the direction of a signal source, according to an embodiment of the present invention; and

FIGS. 7, 8, and 9 are flowcharts showing the method of finding the direction of the signal source, as shown in FIG. 6, in more detail.

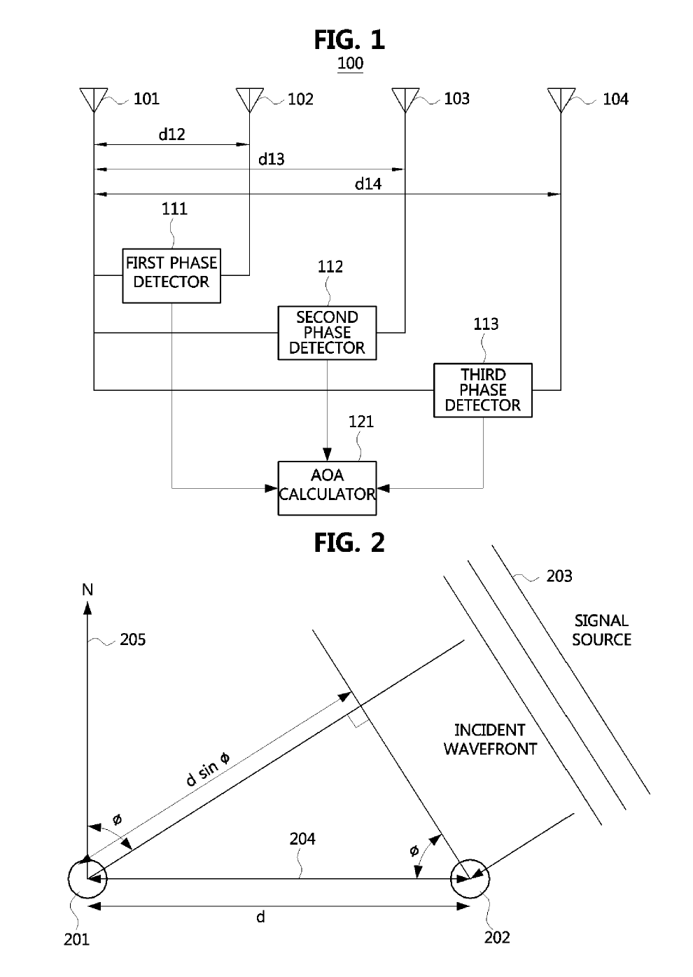

### DESCRIPTION OF EXAMPLE EMBODIMENTS

Example embodiments of the present invention are disclosed herein. However, specific structural and functional details disclosed herein are merely representative for purposes of describing example embodiments of the present invention; that is, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises”, “comprising,”, “includes,” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings. In the following description, for easy understanding, like numbers refer to like elements throughout the description of the figures, and the same elements will not be described further.

Hereinafter, a method of finding the direction of a signal source using phase comparison which is the operation principle of an apparatus and method for finding the direction of a signal source, according to embodiments of the present invention, will be described.

FIG. 2 is a conceptual view for explaining a method of finding the direction of a signal source using phase comparison.

Referring to FIG. 2, when a first antenna 201 is spaced by a distance d from a second antenna 202, and a signal with a wavelength of λ transmitted from a signal source 203 is received by the first and second antennas 201 and 202, the signal received by the first antenna 201 has a phase difference of ΔΨ from the signal received by the second antenna 202.

Meanwhile, if an angle of arrival (AOA) of the signals received by the first and second antennas 201 and 202 is φ with respect to an imaginary line 205 perpendicular to a base line 204 of the first and second antennas 201 and 202, the relationship between the wavelength and phase of the signal received by the second antenna 202 can be expressed by equation 1, below.

λ:d sin φ=2π:ΔΨ (1)

Equation 1 is used to obtain the phase difference ΔΨ between the signals respectively received by the first and second antennas 201 and 202, and the phase difference ΔΨ can be rewritten as equation 2, below.

$$Δ Ψ = \frac{d sin φ \cdot 2 π}{λ} = ( 2 π d / λ ) sin φ \qquad ( 2 )$$

Also, equation 2 can be rewritten in terms of the AOA φ of the signal source 203 as equation 3 below.

φ=sin⁻¹ (ΔΨλ/2πd) (3)

That is, as shown in equation 3, if the phase difference ΔΨ between the signals received by the first and second antennas 201 and 202 is obtained, the AOA φ of the signal source 203 can be calculated.

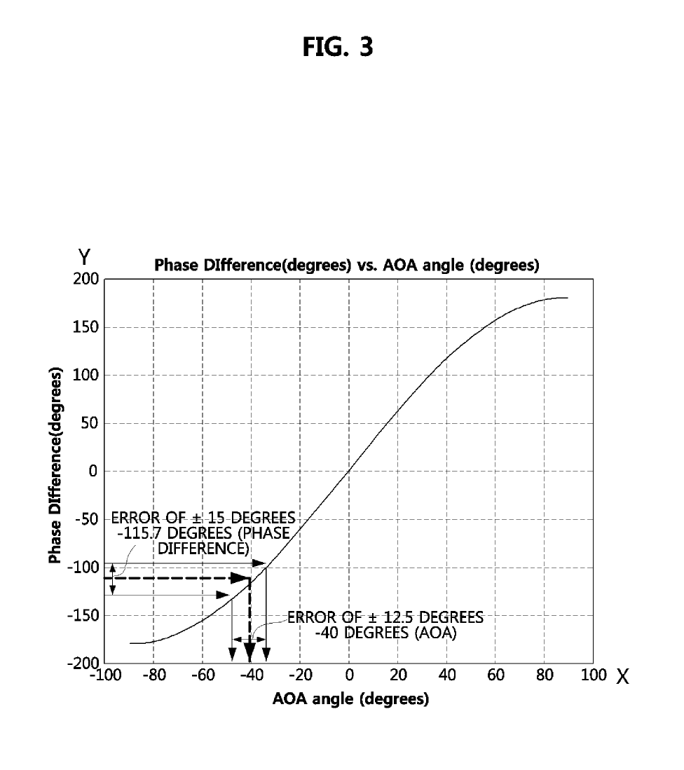

FIG. 3 is a graph showing the relationship between phase differences and AOAs when the distance between two antennas is a half-wavelength (that is, d=λ/2).

In FIG. 3, the x-axis represents an AOA φ (degrees) of signals received by the two antennas, and the y-axis represents the phase difference ΔΨ (degrees) between the received signals.

As shown in FIG. 3, if the distance between the two antennas is λ/2, there is no ambiguity of an AOA value φ corresponding to a phase difference value ΔΨ, and accordingly, the phase difference value ΔΨ corresponds to the single AOA value φ.

For example, it can be seen in FIG. 3 that when a phase difference value ΔΨ has an error of ±15 degrees from −115.7 degrees, the corresponding AOA φ has an error of ±12.5 degrees from −40 degrees.

Meanwhile, it can be seen in FIG. 3 that as the AOA φ approaches about 90 degrees, the slope of the graph becomes gradual, and accordingly the error of an AOA φ that is caused by the error of a phase difference ΔΨ significantly increases.

Accordingly, in the method of finding the direction of the signal source using phase comparison, when the distance between two antennas is a half-wavelength, an AOA φ should be used within the range of about ±65 degrees in which the graph of FIG. 3 is linear in order to reduce the error of the AOA φ.

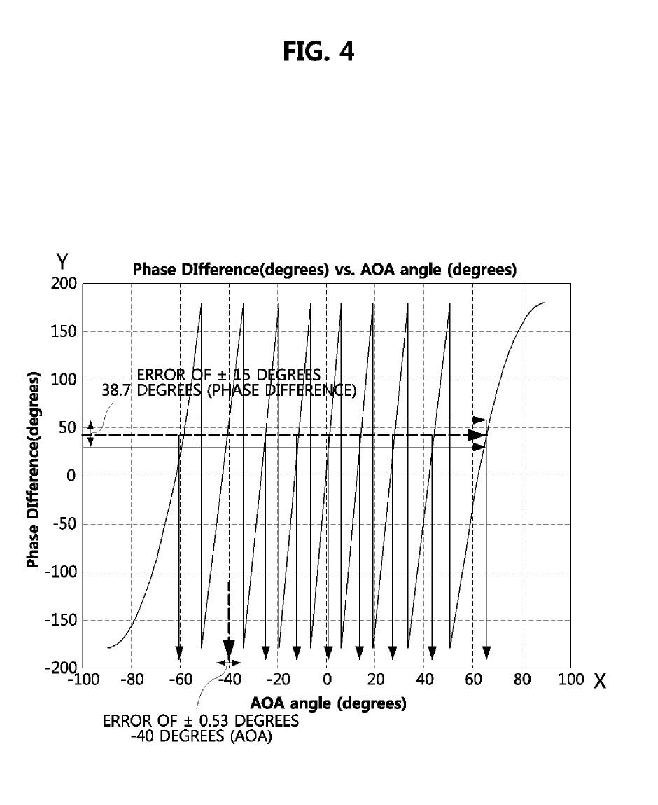

FIG. 4 is a graph showing the relationship between phase differences and AOAs when the distance between two antennas is longer than a half-wavelength, wherein the graph corresponds to the case in which the distance between the two antennas is 4.5 times of a wavelength (that is, d=4.5λ).

In FIG. 4, the x-axis represents an AOA φ (degrees) of signals received by the two antennas, and the y-axis represents the phase difference ΔΨ (degrees) between the received signals.

As shown in FIG. 4, if the distance between the two antennas is 4.5 times of a wavelength (d=4.5λ), there is an ambiguity in which a phase difference value ΔΨ corresponds to several AOA values φ. For example, if a phase difference value is 38.7 degrees, there is an ambiguity problem that the phase difference value of 38.7 degrees corresponds to a plurality of AOAs of −61 degrees, −40 degrees, −24 degrees, −12 degrees, 2 degrees, 13 degrees, 27 degrees, 44 degrees, and 67 degrees. However, if the ambiguity problem can be solved since the slope of the graph is very steep, the error of an AOA will be very small although an error is generated in the corresponding phase difference value.

For example, it can be seen in FIG. 4 that if a phase difference value has an error of ±15 degrees from 38.7 degrees, like the example of FIG. 2, an AOA of −40 degrees, which is one among a plurality of AOAs corresponding to the phase difference value of 38.7 degrees, has a very small error of ±0.53 degrees.

The apparatus and method for finding the direction of the signal source, according to the embodiments of the present invention, can accurately find the direction of a signal source, can be implemented at a low cost with a simple configuration, and also can be applied to a wide band of frequencies, in consideration of the characteristics as described above with reference to FIGS. 2, 3, and 4.

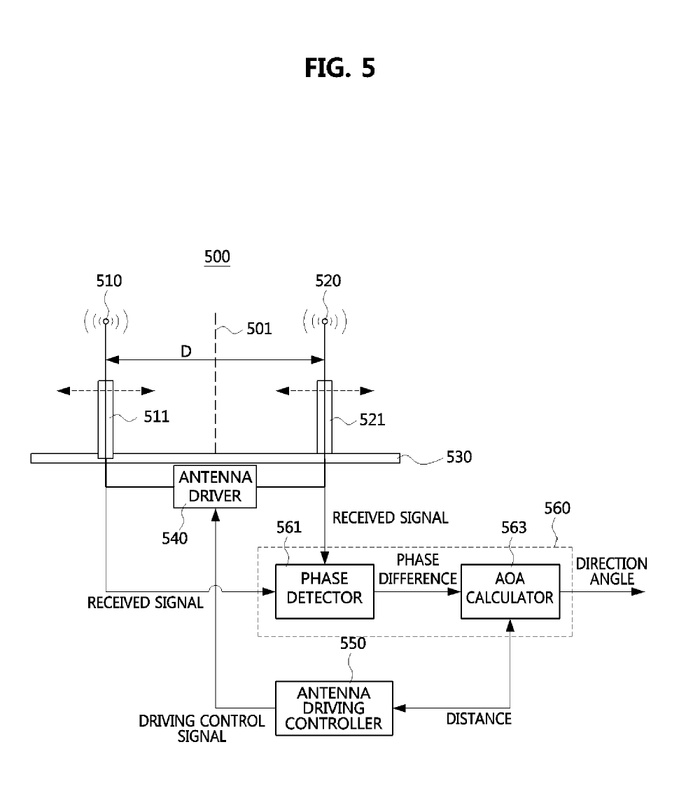

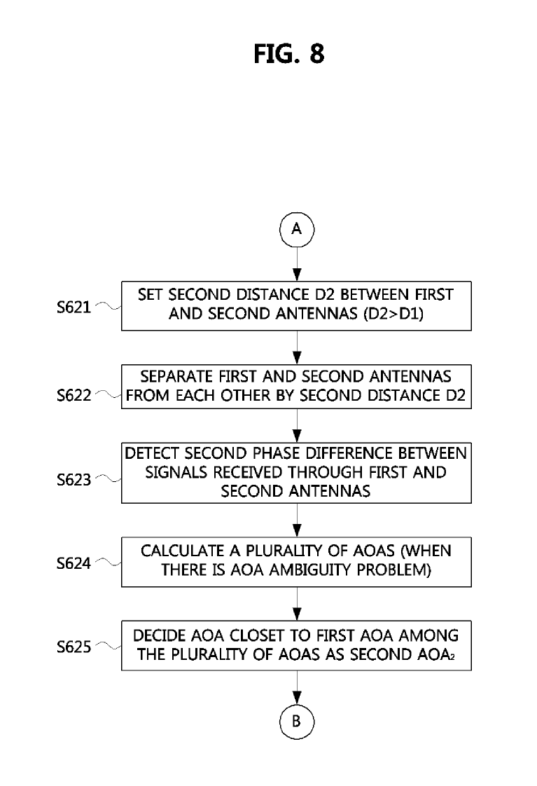

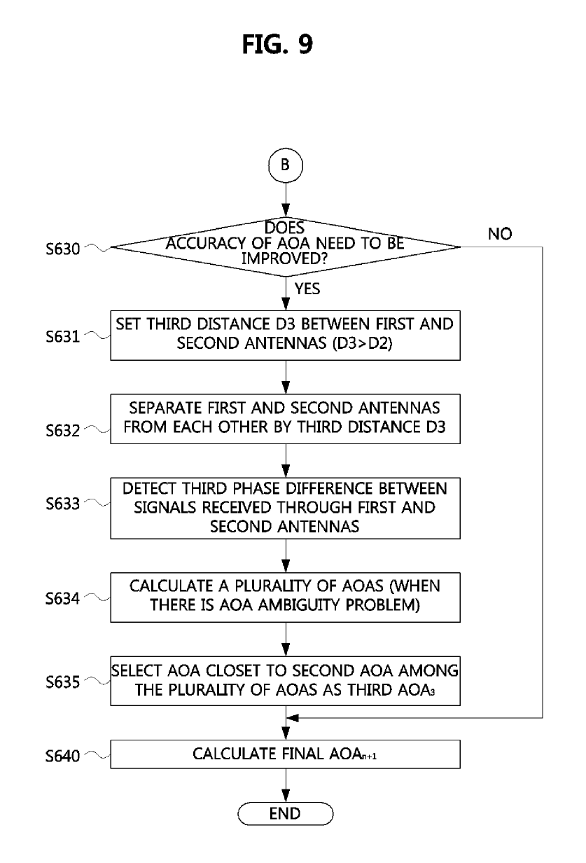

Hereinafter, an apparatus and method for finding the direction of a signal source, according to embodiments of the present invention, will be described in detail with reference to FIGS. 5 through 9.

FIG. 5 is a block diagram showing an apparatus 500 of finding the direction of a signal source, according to an embodiment of the present invention.

Referring to FIG. 5, the apparatus 500 of finding the direction of the signal source includes a first antenna 510, a second antenna 520, an antenna travel guide unit 530, an antenna driver 540, an antenna driving controller 550, and a direction finding unit 560.

The first and second antennas 510 and 520 receive radio signals transmitted from a signal source and provide the received radio signals to the direction finding unit 560.

Also, the first and second antennas 510 and 520 are mechanically coupled with the antenna travel guide unit 530 and installed to be linearly movable along a travel path formed on the antenna travel guide unit 530 so that the distance D between the first and second antennas 510 and 520 is adjusted. Here, the first and second antennas 510 and 520 may linearly move to be close to or away from the center axis 501 of the antenna travel guide unit 530. Or, the first antenna 510 may be fixed at one end of the antenna travel guide unit 530, and the second antenna 520 may linearly move close to or away from the first antenna 510 along the travel path formed on the antenna travel guide unit 530. Or, the second antenna 520 may be fixed at one end of the antenna travel guide unit 530, and the first antenna 510 may linearly move close to or away from the second antenna 520 along the travel path formed on the antenna travel guide unit 530.

The antenna travel guide unit 530 supports the first and second antennas 510 and 520, and provides a linear path along which the first and second antennas 510 and 520 linearly move close to or away from each other.

The antenna driver 540 provides a driving force for linearly moving the first and second antennas 510 and 520 close to or away from each other along the linear travel path formed on the antenna travel guide unit 530 in response to a driving control signal provided by the antenna driving controller 550. The antenna driver 540 may provide a driving force to both the first and second antennas 510 and 520 such that the first and second antennas 510 and 520 simultaneously move close to or away from each other, or a driving force to one of the first and second antennas 510 and 520 such that only the corresponding antenna linearly moves.

A coupling structure for linear movement of the first and second antennas 510 and 520 may be implemented by various well-known methods.

For example, the first and second antennas 510 and 520 may be installed in antenna support units 511 and 521 for supporting the first and second antennas 510 and 520, respectively, and the antenna travel guide unit 530 may be configured in the form of a rail to be mechanically coupled with the lower parts of the antenna support units 511 and 521. Also, a rack gear may be provided in the rail of the antenna travel guide unit 530 in the length direction. Also, motors are fixed at the lower parts of the antenna support units 511 and 521, and a pinion gear is provided at the end of the rotation shaft of each motor so that the rack gear is coupled with the pinion gear. According to the structure described above, the motors fixed at the lower parts of the antenna support units 511 and 521 function as the antenna driver 540, and when a driving control signal (for example, a current signal) is applied to the motors, the rotation shaft of each motor rotates in a predetermined direction so that the pinion gear fixedly coupled with the rotation shaft of the motor rotates in the state of being coupled with the rack gear. As a result, the first and second antennas 510 and 520 with the motors attached thereto linearly move along the rail with the rack gear therein. Accordingly, by controlling the rotation angles of the rotation shafts of the motors through an electrical signal that is applied to the motors to cause the antenna support units 511 and 521 to linearly move by distances corresponding to the rotation angles of the rotation shafts, the distance D between the first and second antennas 510 and 520 can be adjusted.

The antenna driving controller 550 may provide the antenna driver 540 with a driving control signal for adjusting the distance D between the first and second antennas 510 and 520. Here, the antenna driving controller 550 may provide the antenna driver 540 with a driving control signal for adjusting the distance D between the first and second antennas 510 and 520 according to a predetermined antenna driving control method, and provide the direction finding unit 560 with information regarding the distance D between the first and second antennas 510 and 520. For example, the antenna driving controller 550 may provide the antenna driver 540 with a driving control signal for stepwisely increasing the distance D between the first and second antennas 510 and 520, starting from the shortest distance among a plurality of predetermined distances between the first and second antennas 510 and 520.

Or, the antenna driving controller 550 may provide the antenna driver 540 with a driving control signal for setting the distance D between the first and second antennas 510 and 520 to a distance indicated by a distance control signal provided from the direction finding unit 560 or a separate external device.

Or, the antenna driving controller 550 may provide the antenna driver 540 with a driving control signal for adjusting the distance D between the first and second antennas 510 and 520 in real time according to a distance control signal provided from the direction finding unit 560 or a separate external device.

The direction finding unit 560 may detect a phase difference between received signals provided from the first and second antennas 510 and 520, and find the direction angle (AOA) of the corresponding signal (or the direction of a signal source) received through the first and second antennas 510 and 520 based on the detected phase difference and the distance D between the first and second antennas 510 and 520.

In detail, the direction finding unit 560 may include a phase detector 561 and an AOA calculator 563.

The phase detector 561 receives signals from the first and second antennas 510 and 520, compares the phases of the received signals to each other to detect the phase difference between the two signals, and provides information regarding the detected phase difference to the AOA calculator 563.

The AOA calculator 563 calculates a direction angle (or AOA) of the received signals based on the phase difference information provided from the phase detector 561 and the information regarding the distance between the first and second antennas 510 and 520, provided from the antenna driving controller 550, and then outputs information regarding the calculated AOA. Here, the AOA calculator 563 may be configured to provide the antenna driving controller 550 with a distance control signal for setting the distance D between the first and second antennas 510 and 520, and in this case, the AOA calculator 563 may calculate an AOA without having to receive distance information from the antenna driving controller 550.

Also, the AOA calculator 563 determines whether the accuracy of the AOA needs to be improved based on the calculated AOA value, and if it is determined that the accuracy of the AOA needs to be improved, the AOA calculator 563 provides a distance control signal for increasing the distance D between the first and second antennas 510 and 520 to the antenna driving controller 550 so that the antenna driving controller 550 increases the distance D between the first and second antennas 510 and 520. Then, the AOA calculator 563 receives information regarding the phase difference between signals received through the first and second antennas 510 and 520 from the phase detector 561 to thus calculate an AOA.

The AOA calculator 563 may calculate the AOA using equation 3, and if there is the ambiguity problem in which a plurality of AOAs exist in correspondence to the phase difference provided from the phase detector 561, the AOA calculator 563 may select an AOA closest to the previously calculated AOA from among the plurality of AOAs, thus outputting the selected AOA as a final AOA.

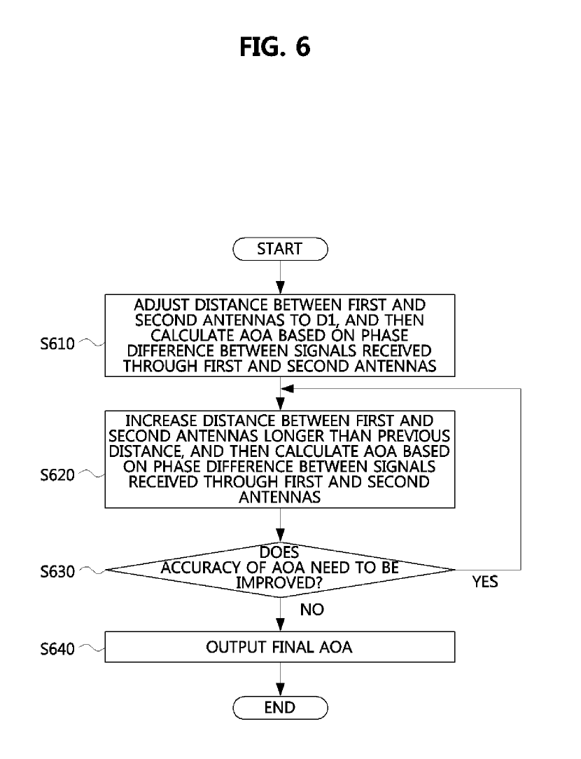

FIG. 6 is a flowchart showing a method of finding the direction of a signal source, according to an embodiment of the present invention, wherein the method of finding the direction of the signal source is performed by the direction finding apparatus as shown in FIG. 5.

Referring to FIG. 6, the direction finding method according to the current embodiment controls linear movement of a first antenna and/or a second antenna to set the distance between the first and second antennas to D1, then detects the phase difference between signals received through the first and second antennas, and calculates an AOA based on the detected phase difference and the distance D1, wherein the distance D1 may be set to a distance that is equal to or shorter than a half-wavelength (D1≦λ/2) (S610).

Thereafter, in order to improve the accuracy of the AOA, the direction finding apparatus sets the distance D1 between the first and second antennas to a distance longer than the distance D1, then detects the phase distance between signals received through the first and second antennas, and calculates an AOA based on the detected phase difference and the newly set distance (S620). Due to the increase in distance between the first and second antennas, there may be ambiguity in which a plurality of AOAs exist in correspondence to the phase difference between signals received through the first and second antennas. In this case, by selecting an AOA closet to the previously calculated AOA from among the plurality of AOAs to thus decide the selected AOA as a final AOA, the direction finding apparatus can solve the ambiguity problem.

Thereafter, it is determined whether the accuracy of the AOA needs to be improved (S630), and if the accuracy of the AOA needs to be improved, the process returns to operation S620 of increasing the distance between the first and second antennas and calculating an AOA based on the phase difference between signals received through the first and second antennas and the increased distance between the first and second antennas.

Meanwhile, if it is determined in operation S630 that the accuracy of the AOA does not need to be improved, the AOA calculated in operation S620 is output as a final AOA (S640).

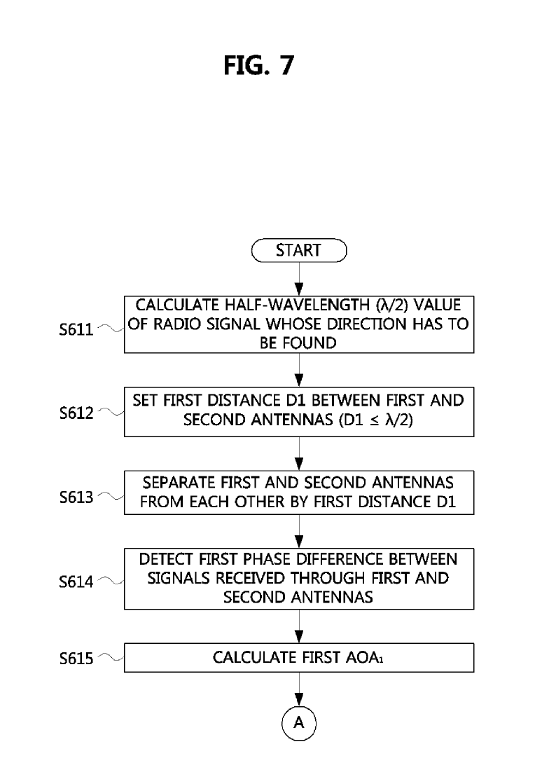

FIGS. 7, 8, and 9 are flowcharts showing the method of finding the direction of the signal source, as shown in FIG. 6, in more detail, and show an example of stepwisely increasing the distance between the first and second antennas and calculating an AOA three times.

Referring to FIGS. 7, 8, and 9, first, the direction finding apparatus calculates the half-wavelength λ/2 of a signal whose direction has to be found (S611). At this time, the direction finding apparatus may calculate the half-wavelength (λ/2) value of a signal whose direction has to be found, based on the frequencies of signals received through the first and second antennas.

Then, the direction finding apparatus may set the distance between the first and second antennas to a first distance D1 that is equal to or shorter than the half-wavelength λ/2 so that there is no ambiguity problem when an AOA of received signals is calculated (S612). At this time, the direction finding apparatus may set the first distance D1 based on the results of a test that has been repeatedly performed to establish the relationship between the distance between the first and second antennas and the ambiguity so that there is no ambiguity problem.

Then, the direction finding apparatus moves the first antenna and/or the second antenna such that the first antenna is spaced by the first distance D1 from the second antennas (S613). At this time, the antenna driving controller of the direction finding apparatus may provide a driving control signal to the antenna driver, and the antenna driver may linearly move the first antenna and/or the second antenna in response to the driving control signal, thereby separating the first antenna by the first distance D1 from the second antenna.

Thereafter, the direction finding apparatus detects a first phase difference between signals received through the first and second antennas spaced by the first distance D1 (S614). At this time, detection of the first phase difference may be performed by the phase detector of the direction finding apparatus.

Then, a first AOA AOA₁ is calculated based on the first phase difference and the first distance D1 (S615). At this time, the first AOA AOA₁ may be calculated by the AOA calculator of the direction finding apparatus or by equation 3 defined above.

After the first AOA AOA₁ is calculated through the process described above, a process for improving the accuracy of direction finding by reducing an error of the first AOA AOA₁, which can be caused due to an error of the first phase difference, is performed.

First, the direction finding apparatus sets the distance between the first and second antennas to a second distance D2 that is longer than the first distance D1 (S621). Here, the second distance D2 may be set to be longer than the half-wavelength λ/2. However, if the distance between the first and second antennas exceeds the first distance D1, that is, exceeds the half-wavelength λ/2, there may be an ambiguity in which a plurality of AOAs exist in correspondence to the phase difference between signals received through the first and second antennas, which has been shown in FIG. 4. In this case, an AOA closest to the first AOA AOA₁ previously calculated (that is, in operations S611 through S615) among the plurality of AOAs is selected and decided as a second AOA AOA₂, thereby solving the ambiguity problem. Accordingly, the second distance D2 may be set to a longest distance within a distance range in which an AOA closest to the first AOA AOA₁ can be definitely selected from among a plurality of AOAs having the ambiguity.

Thereafter, the direction finding apparatus moves the first antenna and/or the second antenna such that the first antenna is spaced by the second distance D2 from the second antenna (S622). At this time, the antenna driving controller of the direction finding apparatus may provide a driving control signal to the antenna driver, and the antenna driver may linearly move the first antenna and/or the second antenna in response to the driving control signal, thereby separating the first and second antennas from each other by the second distance D2.

Thereafter, the direction finding apparatus detects a second phase difference between first and second signals respectively received through the first and second antennas spaced by the second distance D2 (S623). At this time, the detection of the second phase difference may be performed by the phase detector of the direction finding apparatus.

Then, a plurality of AOAs are calculated based on the second phase difference value and the second distance D2 (S624). At this time, there may be the ambiguity problem in which a plurality of AOAs exist in correspondence to the second phase difference value.

Then, the direction finding apparatus decides an AOA closet to the first AOA AOA₁ among the plurality of AOAs corresponding to the second phase difference value, as a second AOA AOA₂ (S625), thereby solving the ambiguity problem.

After the second AOA AOA₂ is calculated through the process described above, the direction finding apparatus determines whether the accuracy of the AOA needs to be improved (S630). At this time, the direction finding apparatus may compare an error of the second AOA AOA2 to a predetermined reference value, and if the error of the second AOA AOA2 is greater than the predetermined reference value, the direction finding apparatus may determine that the accuracy of the AOA needs to be improved.

If it is determined in operation S630 that the accuracy of the AOA does not need to be improved, the direction finding apparatus decides the second AOA AOA₂ as a final AOA (S640).

Meanwhile, if it is determined in operation S630 that the accuracy of the AOA needs to be improved, the direction finding apparatus sets the distance between the first and second antennas to a third distance that is longer than the second distance D2 (S631). Here, the third distance D3 may be set to a longest distance within a distance range in which an AOA closest to the second AOA AOA₂ can be definitely selected from among a plurality of AOAs having ambiguity.

Thereafter, the direction finding apparatus moves the first antenna and/or the second antenna such that the first antenna is spaced by the third distance D3 from the second antenna (S632). At this time, the antenna driving controller of the direction finding apparatus may provide a driving control signal to the antenna driver, and the antenna driver may linearly move the first antenna and/or the second antenna in response to the driving control signal, thereby separating the first and second antennas from each other by the third distance D3.

Thereafter, the direction finding apparatus detects a third phase difference between first and second signals received through the first and second antennas spaced by the third distance D3 (S633). At this time, the detection of the third phase difference may be performed by the phase detector of the direction finding apparatus.

Then, at least one AOA is calculated based on the third phase difference value and the third distance D3 (S634). At this time, there may be the ambiguity problem in which a plurality of AOAs exist in correspondence to the third phase difference value. In this case, the AOA calculator of the direction finding apparatus sets an AOA closet to the second AOA AOA₂ among the plurality of AOAs corresponding to the third phase difference, as a third AOA AOA₃, thereby solving the ambiguity problem (S635).

Thereafter, the direction finding apparatus outputs the third AOA AOA₃ as a final AOA AOAₙ₊₁, where n is a natural number equal to or greater than 1 (S640).

The method of finding the direction of the signal source, as shown in FIGS. 7, 8, and 9, shows an example of improving the accuracy of an AOA while linearly moving the first and second antennas such that the distance between the first and second antennas stepwisely increases to a first distance, a second distance, and a third distance; however, the direction finding method is not limited to the example of calculating an AOA three times, and operation of calculating an AOA may be performed more or less than three times according to the accuracy of the calculated AOA.

While the example embodiments of the present invention and their advantages have been described in detail, it should be understood that various changes, substitutions and alterations may be made herein without departing from the scope of the invention.

What is claimed is:

1. A direction finding apparatus comprising:
a first and second antennas configured to receive radio signals respectively;
a travel guide unit mechanically coupled with the first and second antennas and configured to provide a travel path along which the first and second antennas are linearly movable;
a driver configured to provide a driving force for linearly moving at least one antenna of the first and second antennas in response to a driving control signal;
a driving controller configured to provide the driving control signal, wherein the driving control signal is used to separate the first and second antennas from each other by a predetermined distance; and
a direction finding unit configured to calculate an angle of arrival (AOA) of radio signals respectively received through the first and second antennas, based on the phase difference between the radio signals, and the predetermined distance.

2. The direction finding apparatus of claim 1, wherein the driving controller provides the driving control signal to linearly move the first and second antennas on the travel guide unit so that the first and second antennas are close to or away from each other.

3. The direction finding apparatus of claim 1, wherein the driving controller provides the driving control signal to the driver to stepwisely increase the distance between the first and second antennas.

4. The direction finding apparatus of claim 1, wherein the driving controller provides the driving control signal to adjust the distance between the first and second antennas to a first distance which is equal to or shorter than a half-wavelength of the radio signals, and the direction finding unit calculates a first AOA, based on the phase difference between radio signals received through the first and second antennas spaced by the first distance, and the first distance.

5. The direction finding apparatus of claim 4, wherein after calculating the first AOA, the driving controller provides a driving control signal for separating the first and second antennas from each other by a second distance that is longer than the first distance, and the direction finding unit calculates a second AOA, based on the phase difference between radio signals received through the first and second antennas spaced by the second distance, and the second distance.

6. The direction finding apparatus of claim 5, wherein if a plurality of AOAs are calculated based on the phase difference between the radio signals received through the first and second antennas and the second distance, the direction finding unit decides an AOA closest to the first AOA among the plurality of AOAs, as the second AOA.

7. The direction finding apparatus of claim 1, wherein the direction finding unit determines whether the accuracy of AOA needs to be improved based on the calculated AOA, and if the accuracy of AOA needs to be improved, the direction finding unit provides the driving controller with a distance control signal for setting the distance between the first and second antennas to a distance that is longer than the predetermined distance.

8. The direction finding apparatus of claim 1, wherein the direction finding unit comprises:
a phase detector configured to detect the phase difference between the radio signals respectively received from the first and second antennas; and
an AOA calculator configured to calculate the AOA based on the detected phase difference and the predetermined distance.

9. A method of finding the direction of a signal source, comprising:
moving at least one antenna of two antennas to adjust the distance between the two antennas to a first distance;
calculating a first angle of arrival (AOA) of signals respectively received through the two antennas, based on the phase difference between the received signals, and the first distance;
moving at least one antenna of the two antennas to adjust the distance between the two antennas to a second distance that is longer than the first distance; and
calculating a second AOA of signals respectively received through the two antennas spaced by the second distance, based on the phase difference between the received signals, and the second distance.

10. The method of claim 9, further comprising deciding, if a plurality of AOAs of the signals received through the two antennas spaced by the second distance are calculated based on the phase difference between the received signals and the second distance, an AOA closest to the first AOA among the plurality of AOAs, as the second AOA.

11. The method of claim 9, further comprising:
determining, after calculating the second AOA, whether the accuracy of AOA needs to be improved based on the calculated AOA;
moving at least one antenna of the two antennas to adjust the distance between the two antennas to a third distance that is longer than the second distance, if the accuracy of AOA needs to be improved; and
calculating a third AOA of signals respectively received through the two antennas spaced by the third distance, based on the phase difference between the received signals, and the third distance.

12. The method of claim 11, wherein the calculating of the third AOA comprises deciding, if a plurality of AOAs of the signals received through the two antennas spaced by the third distance are calculated based the phase difference between the received signals and the third distance, an AOA closest to the second AOA among the plurality of AOAs, as the third AOA.

13. The method of claim 9, wherein the first distance is set to a distance that is equal to or shorter than a half-wavelength of the received signals, and the second distance is set to a distance that is longer than the first distance and set to a distance within a distance range in which if a plurality of AOAs of the signals received through the two antennas spaced by the second distance are calculated based on the phase difference between the received signals and the second distance, an AOA closest to the first AOA is able to be selected from among the plurality of AOAs.
